(19) United States
(12) Patent Application Publication
(10) Pub. No.: US 2025/0341727 A1
(43) Pub. Date: Nov. 6, 2025

(54) DISPLAY SYSTEMS FOR SIGHTING OPERATIONS, AND RELATED METHODS, APPARATUS, AND SIGHT DEVICES

(71) Applicant: Styled Brands Inc. (DBA Apex Optics), Calgary (CA)

(72) Inventor: Vanja KRTOLICA, Calgary (CA)

(21) Appl. No.: 19/199,155

(22) Filed: May 5, 2025

Related U.S. Application Data
(60) Provisional application No. 63/643,114, filed on May 6, 2024.
(60) Provisional application No. 63/684,044, filed on Aug. 16, 2024.

(51) Int. Cl. G02B 27/01; F41G 1/38; G02B 23/00; G02B 27/10

(52) U.S. Cl. CPC G02B 27/0189; F41G 1/38; G02B 23/145; G02B 27/10; G02B 2027/0141

(57) ABSTRACT

The present disclosure relates to display systems for sighting operations, and related methods, apparatus, and sight devices. In one or more embodiments, a display system for sighting operations includes a sight elevation section indicating a sight elevation of a sight device, and one or more target sections corresponding respectively to one or more targets. The one or more target sections respectively includes a first ballistic indicator indicating a first ballistic parameter of a respective target of the one or more targets, and a second ballistic indicator indicating a second ballistic parameter of the respective target.

### CROSS-REFERENCE TO RELATED APPLICATIONS

This application claims the benefit of U.S. provisional patent application Ser. No. 63/643,114, filed May 6, 2024, and U.S. provisional patent application Ser. No. 63/684,044, filed Aug. 16, 2024, both of which are herein incorporated by reference in their entireties.

### BACKGROUND

### Field

Implementations described herein relate to display systems for sighting operations, and related methods, apparatus, and sight devices. In one or more embodiments, a display unit includes a heads-up display.

### Description of the Related Art

Sighting operations (such as shooting operations) can be limited with respect to modularity such that it can be difficult for users to quickly sight targets at a variety of distances. Moreover, it can be difficult for a user to receive sighting information without removing the user's sight from a target and/or a sight device. It can also be difficult for a user to receive sighting information without obstructing a target.

Therefore, a need exists for improved display systems and sight devices.

### SUMMARY

The present disclosure relates to display systems for sighting operations, and related methods, apparatus, and sight devices. In one or more embodiments, a display unit includes a heads-up display.

In one or more embodiments, a display system for sighting operations includes a sight elevation section indicating a sight elevation of a sight device, and one or more target sections corresponding respectively to one or more targets. The one or more target sections respectively includes a first ballistic indicator indicating a first ballistic parameter of a respective target of the one or more targets, and a second ballistic indicator indicating a second ballistic parameter of the respective target.

In one or more embodiments, a display system for sighting operations includes a level section. The level section includes a first level indicator indicating that a sight device is level with respect to a gravitational direction, and a second level indicator on a first side of the first level indicator. The second level indicator indicates that the sight device is offset from the gravitational direction in a first direction. The level section includes a third level indicator on a second side of the first level indicator. The third level indicator indicates that the sight device is offset from the gravitational direction in a second direction that is opposite of the first direction. The display system includes a time section that includes a time value, and a controller configured to count up or count down the time value.

In one or more embodiments, a sight device includes one or more objective lenses, one or more ocular lenses, one or more magnifying lenses between the one or more objective lenses and the one or more ocular lenses, and a display unit. The display unit is operable to display one or more sections of a display system. The display unit is oriented to illuminate the one or more sections onto a beam splitter between the one or more magnifying lenses and the one or more ocular lenses. The one or more sections of the display system includes a level section, and a time section.

### BRIEF DESCRIPTION OF THE DRAWINGS

The application file contains at least one drawing executed in color. Copies of this patent application with color drawing(s) will be provided by the Office upon request and payment of the necessary fee.

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic partial side view of a sight device including a display unit 110, according to one or more embodiments.

FIG. 2 is a schematic view of a display system, according to one or more embodiments.

FIG. 3 is a schematic view of the display system, according to one or more embodiments.

FIG. 4 is a schematic view of the display system, according to one or more embodiments.

FIG. 5A is a schematic view of a time section at a first time, according to one or more embodiments.

FIG. 5B is a schematic view of the time section at a second time, according to one or more embodiments.

FIG. 6A is a schematic view of a time section at a first time, according to one or more embodiments.

FIG. 6B is a schematic view of the time section at a second time, according to one or more embodiments.

FIG. 6C is a schematic view of the time section at a third time, according to one or more embodiments.

FIG. 7A is a schematic view of a time section at a first time, according to one or more embodiments.

FIG. 7B is a schematic view of the time section at a second time, according to one or more embodiments.

FIG. 7C is a schematic view of the time section at a third time, according to one or more embodiments.

FIG. 8A is a schematic view of a time section at a first time, according to one or more embodiments.

FIG. 8B is a schematic view of the time section at a second time, according to one or more embodiments.

FIG. 8C is a schematic view of the time section at a third time, according to one or more embodiments.

FIGS. 9A-9H are schematic views of respective level sections, according to one or more embodiments.

FIG. 10 is a schematic view of a selector button and two toggle buttons of a button arrangement, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Implementations described herein relate to display systems for sighting operations, and related methods, apparatus, and sight devices. In one or more embodiments, a display unit includes a heads-up display (HUD). In one or more embodiments, a display unit of a sight device receives data from a computer and displays the data to a user on the HUD. The data can include, for example, elevation data and/or windage data associated with making an accurate shot on one or more targets across one or more stages. The data can also include a shooting time, a number of targets, a number of stages, and/or a number of shots for respective target(s). A memory of the display unit can store the data for displaying until new data is received that overwrites at least part of the data. The HUD can display other data to the user, such as a battery level, an aim direction of the sight device, an aim angle of the sight device, a current elevation setting of the sight device, a current windage setting of the sight device, and/or a level of the sight device. The other data may not be received by the display unit but can be monitored by the sight device, such as by using a gyroscope of the sight device. The display systems herein are shown as displayed in a sight device 100 (such as a riflescope). The present disclosure contemplates that the display systems can be displayed in other sight devices, such as rangefinders (e.g., laser rangefinders), binoculars, monoculars, spotting scopes, and other aiming devices (such as prism sights and/or thermal sights, for example).

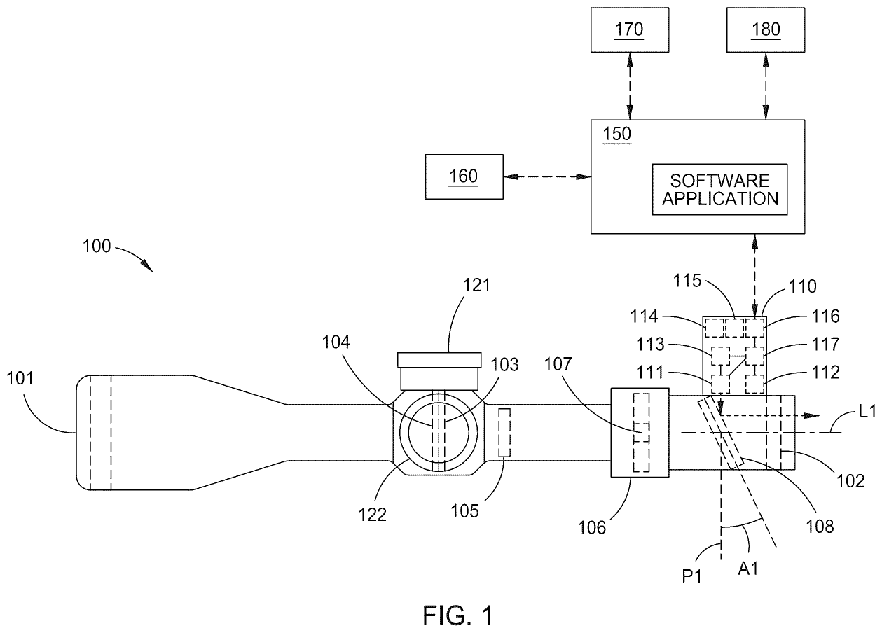

FIG. 1 is a schematic partial side view of the sight device 100 including a display unit 110, according to one or more embodiments.

The sight device 100 includes one or more objective lenses 101, one or more ocular lenses 102, and a reticle 103 and/or one or more magnifying lenses 104 disposed between the objective lens(es) 101 and the ocular lens(es) 102. One or more picture reversal lenses 105 and a magnification adjustment ring 106 including an aperture 107 are disposed between the magnifying lens(es) 104 and the ocular lens(es) 102. A beam splitter 108 is disposed between the magnifying lens(es) 104 and the ocular lens(es) 102. The display unit 110 includes one or more illuminators 111 that are oriented to illuminate one or more sections of a display system onto the beam splitter 108. In one or more embodiments, the beam splitter 108 includes a transparent plate oriented at an angle A1 relative to a plane P1 extending orthogonally relative to a longitudinal axis L1 of the sight device 100. In one or more embodiments, the angle A1 is within a range of 20 degrees to 65 degrees, for example 20 degrees to 50 degrees. In one or more embodiments, the angle A1 is within a range of 30 degrees to 40 degrees, for example 32 degrees to 38 degrees, such as about 35 degrees. The display unit 110 can include one or more of a gyroscope 112, a battery 113, an accelerometer 114, a microphone 115, and/or a receiver/transmitter 116. In one or more embodiments, the display unit 110 includes a controller 117.

The display unit 110 is operable to display any of one or more of the display systems described and/or shown herein. The display unit 110 is in communication with one or more computers 150 (e.g., one or more mobile devices) that calculate and transmit data to the display unit 110. At least some of the data can be calculated using a software application (for example a mobile application) based on input data. Such input data (such as target distance, target elevation minimum wind, maximum wind, humidity, temperature, elevation, air pressure, ammunition load data, and/or ammunition ballistic data) can be input by a user on the computer 150 and/or input by one or more measurement devices 160 in communication with the computer 150 and/or the sight device 100. The measurement device(s) 160 can include for example ballistic weather meter(s), chronograph(s), rangefinders (e.g., laser range finder(s)), and/or other aiming devices (such as binoculars and/or scopes) that include measurement capabilities (such as laser range finding capabilities).

The one or more computers 150 can execute one or more ballistic algorithms to determine elevation data (such as an elevation hold over or under zero—for example in minutes-of angle (MOA) or milliradians (MIL)) and/or windage data (such as a horizontal hold left or right of zero—for example in MOA or MIL). Certain input data, (such as a shooting time, a number of stages, a number of stages, and/or a number of shots for respective target(s)) can be transmitted to the display unit 110 and displayed on the HUD without being altered by calculations. The one or more computers 150 and/or the controller 117 of the sight device 100 can include a memory that stores calculated data and/or input data along with instructions (e.g., software) for handling received/transmitted data carrying out operations of the display unit 110, a processor (such as a central processing unit) to carry out the instructions, and support circuitry. The present disclosure contemplates that the sight device can include one or more onboard measurement devices. For example, a laser rangefinder (LRF) can be onboard the sight device, and can be used to determine distance(s) to target(s) across one or more stages, and the determined distance(s) can be transmitted by the sight device 100 to the computer(s) 150 for purposes of making the ballistic calculations. The present disclosure contemplates that one or more calculations (such as ballistic calculations) described herein can be conducted onboard on the sight device 100. For example, at least one of the one or more computers 150 can be positioned onboard on the sight device 100 or the calculations conducted by the one or more computers 150 can be conducted by the controller 117 of the sight device 100.

The controller 117 can include any form of a general-purpose computer processor that is used for controlling sight devices, and sub-processors thereon or therein. The memory, or non-transitory computer readable medium, can include one or more of a readily available memory such as random access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)), read only memory (ROM), floppy disk, hard disk, flash drive, or any other form of digital storage, local or remote. In one or more embodiments, the memory includes a chip, for example a chip-on-board, such as a chip including silicon and/or germanium. The support circuits of the controller are coupled to the processor and/or the illuminator(s) 111 for supporting the processor and/or the illuminator(s) 111. The support circuits can include cache, power supplies, clock circuits, input/output circuitry and subsystems, and the like. Operational parameters and operations are stored in the memory as a software routine that is executed or invoked to turn the controller 117 into a specific purpose controller to control the operations of the display unit 110 and/or the sight device 100. The controller 117 can be configured to conduct any of the operations described herein. The instructions stored on the memory, when executed, can cause one or more of the operations described herein to be conducted in relation to the sight device 100. For example, the controller 117 can cause one or more of the sections and/or one or more of the markers of the display system 200 to be illuminated.

The calculated data and/or the input data can be stored on a cloud network 170. The communications described can be, for example, a Bluetooth connection. Other connections (such as WiFi connections and/or cellular connections of a cellular network 180) are contemplated.

The accelerometer 114 can detect forces, such as recoil impulses of a device (such as a firearm) to which the sight device 100 is coupled. The microphone 115 can detect noises, such as user instructions and/or shot (e.g., gunshot) noises. In one or more embodiments, the accelerometer 114 and the microphone 115 can both be used to detect shots such that if both the accelerometer 114 and the microphone 115 detect a shot such that the occurrences of false detections is reduced or eliminated.

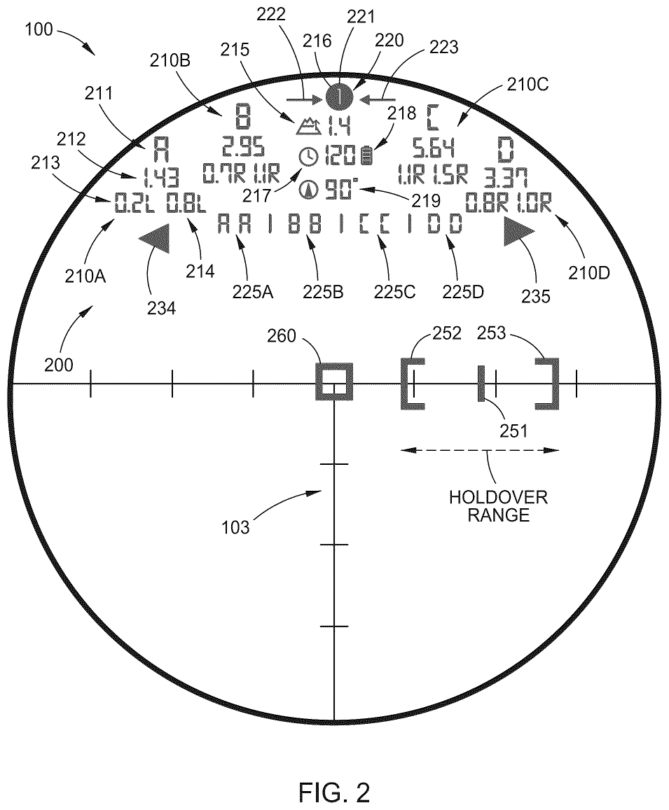

FIG. 2 is a schematic view of a display system 200, according to one or more embodiments. The display system 200 can be displayed using the illuminator(s) 111 (e.g., a display) of the display unit 110 shown in FIG. 1. In one or more embodiments, FIG. 2 shows a first mode (e.g., a competition mode) of the display system. The illuminator(s) 111 can include, for example, a liquid crystal display (LCD), a liquid crystal on silicon (LCoS), digital micro-mirrors (DMDs), and/or light-emitting diode(s) (LEDs) (such as organic light-emitting diode(s) (OLEDs). In one or more embodiments, the illuminator(s) 111 include a microOLED display. In one or more embodiments, the illuminator(s) 111 include a full color OLED display. The reticle 103 is disposed in the first focal plane and the beam splitter 108 is disposed in the second focal plane of the sight device 100. In one or more embodiments, the display system 200 is displayed on a heads-up display (HUD) that uses the illuminator(s) 111 and the beam splitter 108.

The view shown in FIG. 2 can be seen, for example, by a user looking in the sight device 100 in a direction from the ocular lens(es) 102 and to the objective lens(es) 101 shown in FIG. 1. The display system 200 includes one or more target sections 210A-210D corresponding respectively to one or more targets. The one or more targets can include a plurality of targets of a shooting competition. The one or more target sections include a plurality of target sections 210A-210D corresponding respectively to a plurality of targets disposed at a plurality of distances relative to the sight device 100. The distance(s) can be measured, for example, using the measurement devices 160 and/or an onboard device (such as an onboard laser rangefinder (LRF)) of the sight device 100.

The exemplary display system 200 in FIG. 2 shows a first target section 210A corresponding to a first target “A,” a second target section 210B corresponding to a second target “B,” a third target section 210C corresponding to a third target “C,” and a fourth target section 210D corresponding to a fourth target “D.” Other numbers of targets can be used. The four target sections 210A-210D respectively include a target indicator 211 indicating the respective target of the one or more targets, a first ballistic indicator 212 (e.g., an elevation indicator relative to a zero, such as in MOA or MIL) indicating a first ballistic parameter (e.g., an elevation) of a respective target, a second ballistic indicator 213 (e.g., a windage indicator) indicating a second ballistic parameter (e.g., a first windage, such as an average windage) of the respective target, and a third ballistic indicator 214 (e.g., a second windage indicator) indicating a third ballistic parameter (e.g., a second windage, such as a gust windage, for example a maximum windage) of the respective target. In one or more embodiments, the windage of the second ballistic indicator 213 corresponds to a minimum value (e.g., a first wind bracket) of a windage range, and the second windage of the third ballistic indicator 214 corresponds to a maximum value (e.g., a second wind bracket) of the windage range. In one or more embodiments, the windage range varies at a location of the sight device 100 and/or varies along a distance between the sight device 100 and one or more locations of the one or more targets.

The first ballistic indicator 212 includes an elevation numeral, and the second ballistic indicator 213 and the third ballistic indicator 214 respectively include a windage numeral and a directional symbol. The directional symbol can include a horizontal arrow pointing to along a holdover direction or a letter (e.g., “L” for holding over to the left of zero or “R” for holding over to the right of zero).

A sight numeral (shown as an exemplary “1.4” in FIG. 2) of a sight elevation section 215 indicates a sight elevation (such as an elevation setting and/or a current sight elevation) of the reticle 103 of the sight device 100. The sight numeral can be determined, for example, by monitoring the position of an elevation dial 121 (FIG. 1) of the sight device 100. By adjusting the sight numeral for each target to be at or near the respective first ballistic indicator 212, a user can quickly make shots in each target while accounting for the various elevations of the target(s) of each stage. The user can also compare the respective first ballistic indicator 212 to the sight numeral to determine an elevation holdover to be used for the hash marks of the reticle 103. The sight elevation section 215 includes an elevation symbol disposed adjacent to the sight numeral. The elevation symbol can include for example a mountain profile and an upward-pointing arrow.

The first ballistic indicators 212, the second ballistic indicators 213, and the third ballistic indicators 214 can be calculated by the computer(s) 150 and transmitted to the sight device 100. Using the hash marks of the reticle 103, a user can position the target at a windage holdover that is in a range between the value of the second ballistic indicator 213 and the value of the third ballistic indicator 214 for the respective target sections 210A-210D, which facilitates the user quickly making shots in each target while accounting for the various windages of the target(s) of each target. The present disclosure also contemplates that the display system 200 can include a sight windage section that includes a second sight numeral indicating a current sight windage of the reticle. The second sight numeral can be determined, for example, by monitoring the position of a windage dial 122 (FIG. 1) of the sight device 100. By adjusting the second sight numeral for each target to be between the respective second ballistic indicator 213 and respective third ballistic indicator 214, a user can quickly make shots in each target while accounting for the various windages of the target(s) of each stage.

A user can use the ballistic parameters of the target sections 210A-210D to make ballistic adjustments relative to zero to achieve impacts on the targets “A” to” “D” that correspond to the target sections 210A-210D. For example, the elevation dial 121 can be adjusted such that the value indicated by the sight elevation section 215 is at or near the value indicated by the first ballistic indicator 212. As another example, the reticle 103 can be used to holdover relative to zero (or the windage dial 122 can be adjusted relative to zero) such that the a point of aim is between the values indicated by the second ballistic indicator 213 and the third ballistic indicator 214.

The display system 200 shown in FIG. 2 includes a stage indicator 216 (shown as exemplary numeral “1”) which indicates the stage for which the respective target section data is shown. A user can cycle through a plurality of stages. For example, the data of a first stage can be omitted from the display system 200 and the data of a subsequent stage can be displayed after a user cycles from the first stage and to the subsequent stage. For example, a user can switch from a first stage “1” to a second stage “2,” in which data (e.g., the first ballistic indicator 212, the second ballistic indicator 212, and the third ballistic indicator 213) is displayed for the respective one or more target sections 210A-210D of the second stage “2.”

The display system 200 includes a time section 217 and a battery level section 218. The time section 217 includes a time value and a time symbol, and the time symbol is a clock. The time value can indicate a time for an event, such as a time remaining in a stage of a shooting match. The time value counts down (in a timer mode) or counts up (in a stopwatch mode). The time value is a clock time (in a clock mode). The display system 200 includes an aim direction section 219 that includes an aim direction indicator (such as a numeral) and an aim direction symbol). In one or more embodiments, the aim direction indicator includes a geographic direction (such as a compass direction that can be expressed in degrees or hours:minutes), and the direction symbol includes a triangle within a circle.

The display system 200 includes a level section 220 that includes a first level indicator 221 indicating that the sight device is level with respect to a gravitational direction, and a second level indicator 222 on a first side of the first level indicator 221. The second level indicator 222 indicates that the sight device is offset from the gravitational direction in a first direction (e.g., to the left of the sight device 100). The level section 220 includes a third level indicator 223 on a second side of the first level indicator 221. The third level indicator 223 indicates that the sight device 100 is offset from the gravitational direction in a second direction (e.g., to the right of the sight device 100) that is opposite of the first direction. In one or more embodiments, the first level indicator 221 includes a solid circle, the second level indicator 222 includes a first arrow pointing in the second direction, and the third level indicator includes a second arrow pointing in the first direction. The second level indicator 222 and the third level indicator 223 are directionally oriented toward the first level indicator 221. In one or more embodiments, the first level indicator 221 has a solid shape, and the second level indicator 222 and the third level indicator 223 respectively include an apex pointed toward the first level indicator 221. The stage indicator 216 can be disposed in the first level indicator 221. In one or more embodiments, one of the first level indicator 221, the second level indicator 222, or the third level indicator 223 is displayed at a moment. Although certain sections of the display system 200 may be non-illuminated at a moment, FIG. 2 shows all sections of the display system 200 as illuminated for visual clarity purposes.

One or more shot count sections 225A-225D correspond respectively to the one or more targets (e.g., targets “A,” “B,” “C,” and “D”). In one or more embodiments, a number of the one or more shot count sections 225A-225D is equal to a number of the one or more target sections 210A-210D. The one or more shot count sections 225A-225D respectively include one or more target indicators indicating the respective target of the one or more targets. A number of the one or more target indicators for each shot count section 225A-225D is equal to a number of shots used for the respective target. The display system 200 includes a first pan indicator 234 oriented toward a first side of a field of view of the sight device 100, and a second pan indicator 235 oriented toward a second side of the field of view of the sight device 100.

The first pan indicator 234 or the second pan indicator 235 is illuminated based on a location of one or more targets, the aim direction indicator, and/or the aim angle indicator. The illuminated first pan indicator 234 or second pan indicator 235 guides the field of view toward the one or more targets when illuminated. For example, when the first pan indicator 234 is illuminated the user is instructed to pan the field of view of the sight device 100 to the left.

The display system 200 includes marker 251 and a pair of markers 252, 253 disposed along the reticle 103. The marker 251 and the pair of markers 252, 253 can be disposed horizontally along the reticle 103 to account for windage. The marker 251 and/or the pair of markers 252, 253 can be disposed vertically along the reticle 103 to account for elevation (e.g., corresponding to the determined value of the first ballistic indicator 211). The positions of the pair of markers 252, 253 can correspond to the determined values of the second and third ballistic indicators 212, 213. The marker 251 indicates a location of a holdover calculated based on a movement speed of one or more targets (such as a target selected by a user), or another parameter. A user can cycle through the targets such that the positions of the marker 251 and/or the pair of markers 252, 253 change along the reticle 103. A user can cycle through the targets such that the positions of the marker 251 and/or the pair of markers 252, 253 change along the reticle 103. For example, the data of a first target can be omitted from the display system 200 and the data of a subsequent target can be displayed after a user cycles from the first target and to the subsequent target.

The present disclosure contemplates that the cycling described herein can be conducted automatically by the sight device 100 in response to a detection (e.g., using the accelerometer 114 and/or the microphone 115) of one or more gunshots. For example, the sight device 100 can cycle from a first target and to a second target after detection of a number of gunshots corresponding to the number of the first shot count section 210A corresponding to the first target. The present disclosure contemplates that symbols (such as the symbols of the first target section 210A) can be omitted (e.g., non-illuminated) from the display system in response to the detection of one or more gunshots. As an example, a respective symbol (such as one of the “A” symbols shown for the first count section in FIG. 2) can be omitted for each gunshot that is detected such that a user can visually track the number of shots that have already been taken for a respective target and/or a respective stage.

One or both of the marker 251 and the pair of markers 252, 253 can be illuminated. One or more aspects described herein and/or shown in the figures can be omitted. The marker 251 and/or the pair of markers 252, 253 can be omitted. In one or more embodiments, the pair of markers 252, 253 are omitted, and the marker 251 accounts for the movement speed and/or an average of: the second ballistic indicator 213 and the third ballistic indicator 214. In one or more embodiments, the marker 251 is omitted, and the pair of markers 252, 253 account for: the holdover range between the second ballistic indicator 213 and the third ballistic indicator 214, and the movement speed. For example, the holdover range between the second ballistic indicator 213 and the third ballistic indicator 214 can be adjusted by the movement speed.

The marker 251 can indicate a calculated lead value that can correspond, for example, to holdover for a moving target. The calculated lead value can be calculated based on a movement speed of the moving target. The marker 251 can be displayed in addition to the second and third ballistic indicators 213, 214 and/or the pair of markers 252, 253. In one or more embodiments, the marker 251 indicates a location of a holdover calculated based on a movement speed of one or more targets. As described, the pair of markers 252 can indicate a holdover range calculated based on the second ballistic indicator 213 and the third ballistic indicator 214. For example, the left-side marker 252 of the pair of markers can correspond to the indicated value of the second ballistic indicator 213 of a respective target and the right-side marker 253 of the pair of markers can correspond to the indicated value of the third ballistic indicator 214 of the respective target. The respective target can be used-selected or the controller 117 of the sight device 100 can automatically cycle through the targets and automatically display the marker 251 and/or pair of markers 252, 253 corresponding to the respective targets. As an example, the controller 117 can cycle to from a first target and to a second target after detecting a number of shots equal to a shot count for the first target. A calculated lead value for a moving target can be used to adjust (e.g., move left or right based on the movement direction of the moving target) the pair of markers 252, 253.

In one or more embodiments, the marker 251 is in the shape of a hash (such as a hash that matches one or more hashes along a windage axis of the reticle 103). As an example, the hash shape of the marker 251 can be the same size (in MOA or MRAD) as one or more hashes along a windage axis of the reticle 103. In one or more embodiments, the pair of markers 252, 253 are in the shape of end brackets that face each other. Other shapes are contemplated for the marker 251 and the pair of markers 252, 253. As an example, the pair of markers 252, 253 can include hashes in a manner similar to that of the marker 251. As another example, shapes such as solid dots, hollow circles, solid or hollow triangles, solid or hollow stars, chevrons, and solid or hollow arrows can be used for the marker 251 and/or the pair of markers 252, 253.

The marker 251 can account for a lead for a moving target (as described above) and/or one or more other parameters. As an example, the marker 251 can account for an average, a median, a mean, a standard deviation, or another mathematical consideration of the second ballistic indicator 213 and the third ballistic indicator 214. For example, the marker 251 can be positioned at a middle point between the pair of markers 252, 253. As another example, the marker 251 can account for a current wind measurement that takes into account a current gust of the wind. As another example, the marker 251 can account for a target size and/or a target location. For example, the marker 251 can be positioned to correspond to a center of a respective target or an edge of a respective target. The marker 251 and the pair of markers 252, 253 can be displayed in the same color or can be displayed in different colors. For example, the marker 251 can be displayed in red and the pair of markers 252, 253 can be displayed in green, blue, or yellow. Other colors are contemplated.

The present disclosure contemplates that one or more sections 221-223 of the level section 220 can be disposed along the reticle 103. In addition to or in place of the level section 220, a level section 260 is disposed along the reticle 103. In one or more embodiments the level section 260 is aligned with a center of the reticle 103. The level section 260 can enclose the center of the reticle 103. The level section 260 can be non-illuminated when the sight device 100 is offset (e.g., canted) from a level position, and the level section 260 can be illuminated when the sight device 100 is in the level position. The level section 260 can be illuminated in various colors as the sight device 100 moves between the level position and offset (e.g., canted) positions. For example, the level section 260 can be illuminated in a first color (e.g., green or red) when the sight device 100 is in the level position. The level section 260 can change illumination to a second color (e.g., yellow) when the sight device 100 is offset (e.g., canted) in a first direction (e.g., left-side direction), or to a third color (e.g., blue) when the sight device 100 is offset (e.g., canted) in a second direction (e.g., right-side direction). The level section 260, when illuminated in the first color, can provide an indication to a user that the sight device 100 is in the level position for shooting.

FIG. 3 is a schematic view of the display system 200, according to one or more embodiments. The display system 200 can be displayed using the illuminator(s) 111 of the display unit shown in FIG. 1. In one or more embodiments, FIG. 3 shows a second mode (e.g., a tactical mode and/or a hunting mode) of the display system 200. The second mode can omit one or more sections of the display system 200 that are shown in the first mode in FIG. 1.

The view shown in FIG. 3 can be seen, for example, by a user looking in the sight device 100 in a direction from the ocular lens(es) and to the objective lens(es) shown in FIG. 1. The exemplary display system in FIG. 3 shows a single target section.

The exemplary display system 200 includes a single target section 210. A first ballistic label (e.g., an elevation label “E”) is disposed adjacent the first ballistic indicator 212. A second ballistic label (e.g., a first windage label “W1”) is disposed adjacent the second ballistic indicator 213. A third ballistic label (e.g., a second windage label “W2”) is disposed adjacent the third ballistic indicator 214. The display system 200 includes a lead section 228. In one or more embodiments, the lead section 228 includes a label (such as a “LEAD” label) and a lead indicator 229. The lead indicator 229 can indicate a calculated lead value that can correspond, for example, to holdover for a moving target. The calculated lead value can be calculated based on a movement speed of the moving target. The lead section 228 can be displayed in addition to the second and third ballistic indicators 213, 214 and/or the calculated lead value can be used to adjust (e.g., increase or decrease based on the movement direction of the moving target) the indicated values of the second and third ballistics indicators 213, 214. For example, the value indicated by the lead indicator 229 can be added to or subtracted from the respective values indicated by the second and third ballistics indicators 213, 214.

The display system 200 includes an aim angle section 230 including an aim angle indicator (such as a numeral) and an aim angle symbol. In one or more embodiments, the aim angle indicator includes an angle of inclination that is positive or negative, and the aim angle symbol includes two lines and an arcuate line between the two lines.

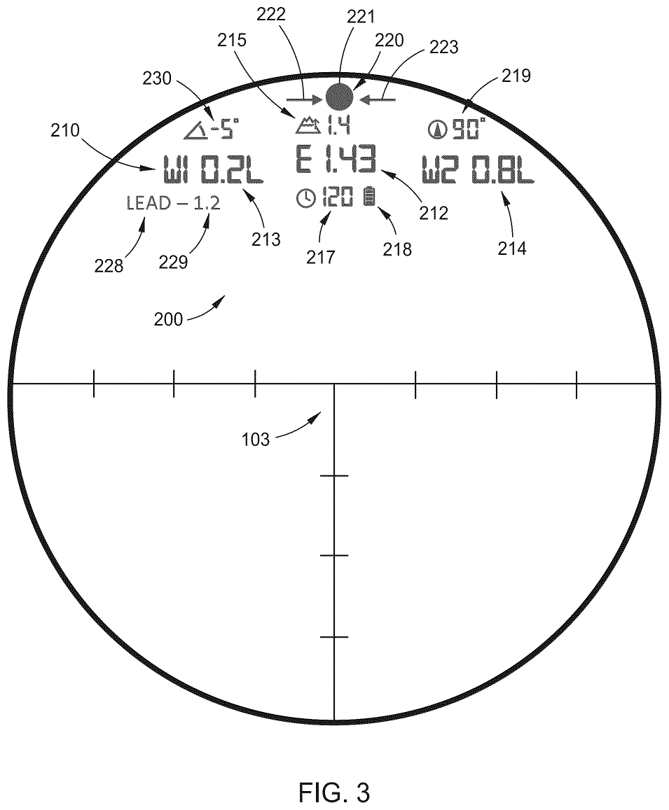

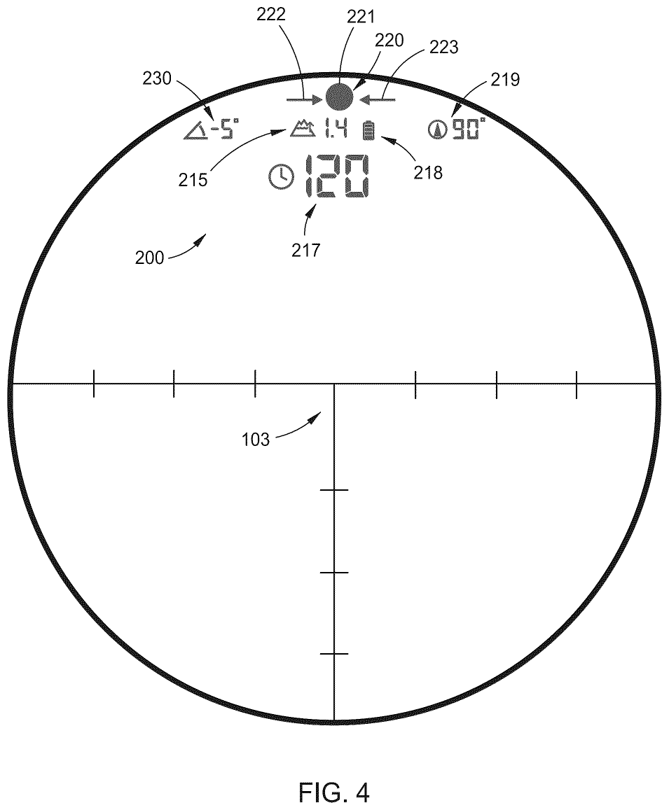

FIG. 4 is a schematic view of the display system 200, according to one or more embodiments. The display system 200 can be displayed using the illuminator(s) 111 of the display unit 110 shown in FIG. 1. In one or more embodiments, FIG. 4 shows a third mode (e.g., a timer mode) of the display system 200. The third mode can omit one or more sections of the display system 200 that are shown in the first mode in FIG. 1. The present disclosure contemplates that the display unit 110 can switch the display system 200 between the first mode shown in FIG. 2, the second mode shown in FIG. 3, and/or the third mode shown in FIG. 3.

The view shown in FIG. 4 can be seen, for example, by a user looking in the sight device in a direction from the ocular lens(es) 102 and to the objective lens(es) 1-1 shown in FIG. 1. The exemplary display system 200 in FIG. 4 includes the level section 220 and the time section 217. The time value can be selected by a user. The time value can correspond, for example, to a time allowed for a stage in a competition. A user can start the time using an input (such as a button of the sight device 100), and the time can count up or count down after started. A format of the time label (e.g., the time value) can be changed between total seconds (as shown) or minutes:seconds.

The level section 220 and the time section 217 can be automatically included in the third mode, and the other sections shown in FIG. 4 can be user-selectable to be turned on or off.

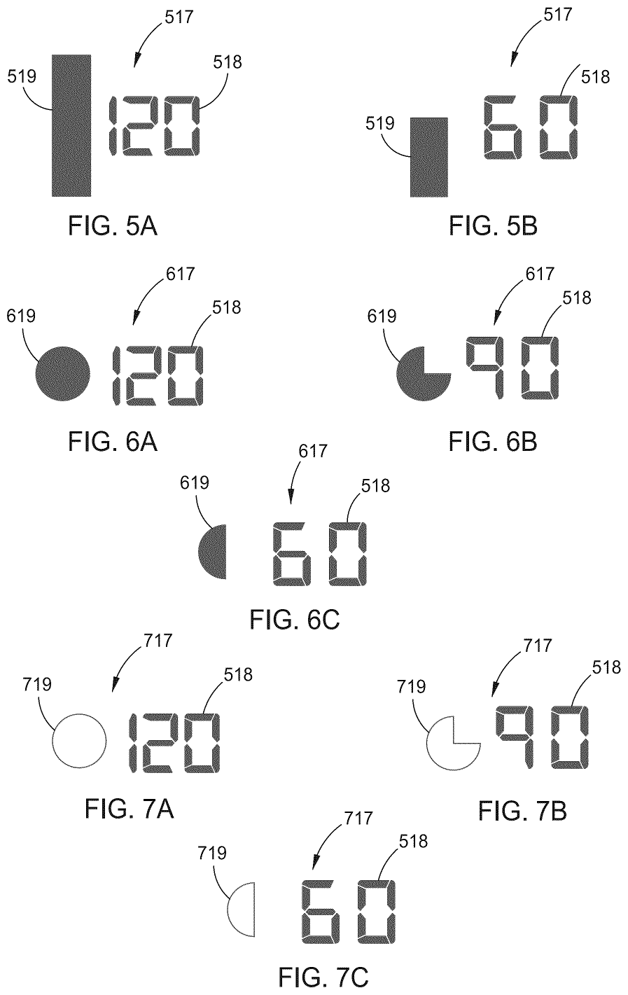

FIG. 5A is a schematic view of a time section 517 at a first time, according to one or more embodiments. The time section 517 can be used in place of the time section 217 shown in FIGS. 2-4.

FIG. 5B is a schematic view of the time section 517 at a second time, according to one or more embodiments. For example, time (such as 60 seconds) has elapsed at the second time relative to the first time.

The time section 517 includes the time value 518 and a visual marker 519 (such as an erosion marker that shortens with time). The visual marker 519 is shown, for example, as a bar. As shown in FIG. 5B, a portion of the visual marker 519 is omitted from display (e.g., eroded) after the time is started, and the portion omitted corresponds to the time that has elapsed (e.g., a time lapse). As an example, in FIG. 5B 60 seconds has elapsed relative to FIG. 5A such that about half of the visual marker 519 is omitted from the display (e.g., omitted from illumination). The visual marker 519 or the time value 518 can be omitted. The visual marker 519 is shown as vertically oriented and can be horizontally oriented.

FIG. 6A is a schematic view of a time section 617 at a first time, according to one or more embodiments. The time section 617 can be used in place of the time section 217 shown in FIGS. 2-4.

FIG. 6B is a schematic view of the time section 617 at a second time, according to one or more embodiments. As an example, in FIG. 6B 30 seconds has elapsed relative to FIG. 6A such that about a fourth of a visual marker 619 is omitted from the display (e.g., omitted from illumination).

FIG. 6C is a schematic view of the time section at a third time, according to one or more embodiments.

The visual marker 619 in FIGS. 6A-6C is shown as a solid circle, and pie-shaped sections of the solid circle are omitted (e.g., eroded) from display in a clockwise (as shown) or counter-clockwise direction.

FIG. 7A is a schematic view of a time section 717 at a first time, according to one or more embodiments. The time section 717 can be used in place of the time section 217 shown in FIGS. 2-4.

FIG. 7B is a schematic view of the time section 717 at a second time, according to one or more embodiments.

FIG. 7C is a schematic view of the time section 717 at a third time, according to one or more embodiments.

A visual marker 719 in FIGS. 7A-7C is shown as a hollow circle, and pie-shaped sections of the hollow circle are omitted (e.g., eroded) from display in a clockwise (as shown) or counter-clockwise direction.

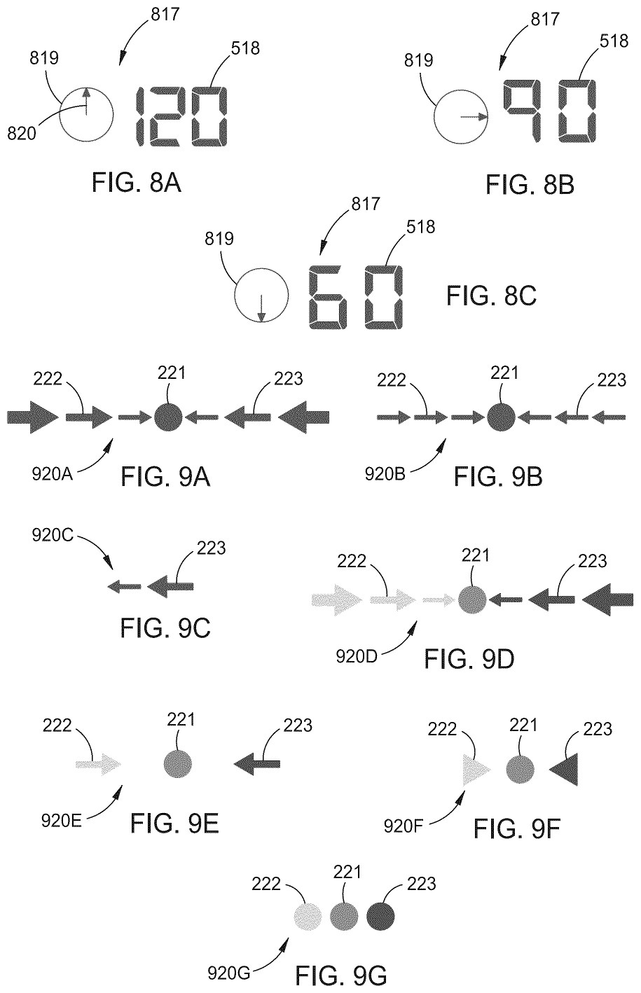

FIG. 8A is a schematic view of a time section 817 at a first time, according to one or more embodiments. The time section 817 can be used in place of the time section 217 shown in FIGS. 2-4.

FIG. 8B is a schematic view of the time section 817 at a second time, according to one or more embodiments.

FIG. 8C is a schematic view of the time section 817 at a third time, according to one or more embodiments.

A visual marker 819 in FIGS. 8A-8C is shown as a hollow circle (such as at least part of a clock), and a marker 820 (such as a clock arm, for example an arrow) moves in a clockwise (as shown) or counter-clockwise direction. The degree of movement of the marker 820 corresponds to a time that has elapsed.

The various time sections described herein can be used in one or more of the display modes described above (such as FIG. 2, FIG. 3, and/or FIG. 4).

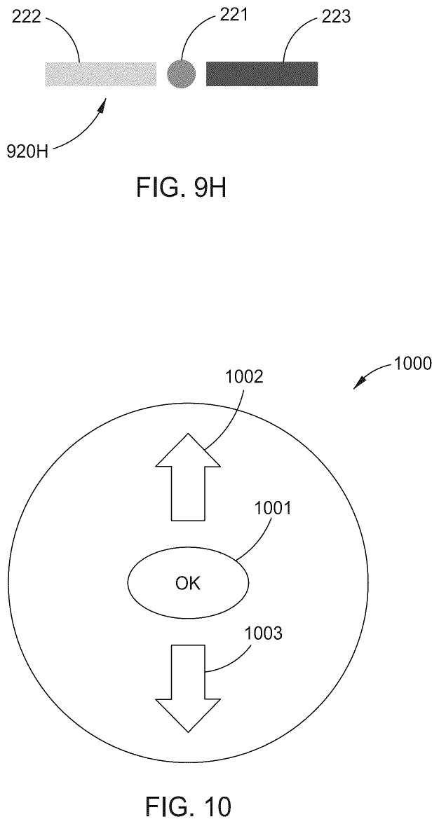

FIGS. 9A-9H are schematic views of respective level sections 920A-920H, according to one or more embodiments.

In FIG. 9A, more of the second level indicators 222 or more of the third level indicators 223 are shown outwardly of the first level indicator 221 as the sight device 100 is more offset (e.g., canted) relative to a level position. In FIG. 9A, larger second level indicators 222 or third level indicators 223 are shown the more offset (e.g., canted), the sight device 100 is relative to a level position. FIG. 9C shows an exemplary implementation where the sight device 100 is offset (e.g., canted) to the right. If the sight device 100 is canted more to the right, then the third, outermost, and largest third level indicator 223 is illuminated in addition to the two smaller third level indicators 223.

In one or more embodiments, the first level indicator 221 is illuminated when the sight device is level at a level position (and the second level indicator(s) 222 and the third level indicator(s) 223 are not illuminated). In one or more embodiments, the second level indicator(s) 222 are illuminated when the sight device 100 is offset (e.g., canted) to the left from the level position (and the first level indicator 221 and the third level indicator(s) 223 are not illuminated). In one or more embodiments, the third level indicator(s) 223 are illuminated when the sight device 100 is offset (e.g., canted) to the right from the level position (and the first level indicator 221 and the second level indicator(s) 222 are not illuminated). The second and third level indicators 222, 223 are shown as arrows. Different shapes (e.g., triangles and/or circles, as describe for example below) can be used for the level indicators.

In FIG. 9B, the implementation is similar to FIGS. 9A and 9C but the second level indicators 222 and the third level indicators 223 are the same size.

In FIG. 9D, the implementation is similar to FIGS. 9A and 9C but the second level indicators 222 and the third level indicators 223 are different colors than the first level indicator 221. For example, the first level indicator 221 has a first color (e.g., green) indicating the level position, the second level indicators 222 have a second color (e.g., yellow, blue, or red) indicating a cant to the left, and the third level indicators 223 have a third color (e.g., yellow, blue, or red) indicating a cant to the right.

In FIG. 9E, a single second level indicator 222 and a single third level indicator 223 are shown on both sides of the first level indicator 221. Optionally, the single second level indicator 222 or the single third level indicator 223 enlarges (as described for the multiple indicators in relation to FIG. 9A and FIG. 9D) as the sight device 100 becomes more offset (e.g., canted), relative to the level position. As the sight device 100 moves closed to the level position to become more level, the single second level indicator 222 or the single third level indicator 223 becomes smaller.

In FIG. 9F, the single second level indicator 222 and the single third level indicator 223 have the shapes of solid triangles.

In FIG. 9G, the single second level indicator 222 and the single third level indicator 223 have the shapes of solid circles.

In FIG. 9H, the single second level indicator 222 and the single third level indicator 223 respectively include a shape (such as a bar) that lengthens with more offset (e.g., cant) and shortens with less offset (e.g., cant).

The first level indicator 221 is shown in the shape of a circle. The shape can be solid or hollow. Other shapes (such as a rectangle, bar, a square, a polygon, a star, a triangle, and arrow, and/or an arrowhead) are contemplated for the first level indicator 221. The second and third level indicators 222, 223 are shown as arrows. Other shapes are contemplated for the second and third level indicators 222, 223, such as triangles (e.g., arrowheads, as shown in FIG. 9E), letters (such as an “L” or “R”), other directional shapes, rectangles, squares, bars, polygons, stars, and/or other shapes (such as solid shapes or hollow shapes).

A custom mode of a display system can include any combination of the display sections described herein turned on or off by a user. As an example, a custom mode might include the level section 220 and the time section 217 illuminated with other sections turned off. As another example, a custom mode might include the level section 220 and the target section(s) 210 illuminated with other sections turned off. The display of a sight device can cycle through the various modes of display systems. For example, a user can cycle through a competition mode, a tactical mode, a hunting mode, a timer mode, and/or one or more custom modes depending on the user's application.

FIG. 10 is a schematic view of a selector button 1001 (e.g., an “OK” button) and two toggle buttons 1002, 1003 of a button arrangement 1000, according to one or more embodiments. The button arrangement 1000 can be pressed by a user to cycle through a menu that can be displayed using the display unit 110, and the menu can be used to configure any mode described herein. As an example, holding down the selector button 1001 can display the menu, cycle to a different view of the menu, and close the menu. As another example, pressing the selector button 1001 can select a section, a marker, or a view to be modified. The toggle buttons 1002, 1003 can be used to change selections of configuration within the menu. For example, the upward toggle button 1002 can change a respective display section to “ON” so the display section is illuminated, and the downward toggle button 1003 can change a respective display section to “OFF” so the display section is omitted from illumination in the display system 200.

The button arrangement 1000 can be positioned on an outer face of the sight device 100. For example, the button arrangement 1000 can be positioned on an outer face of the display unit 110, an outer face of a dial (such as the elevation dial 121, the windage dial 122, a parallax dial, and/or an illumination dial), or an outer face of a section of the sight housing that houses the ocular lens(es) 102.

The subject matter of FIGS. 1-10 can be combined with each other. For example, the first pan indicator 234, the second pan indicator 235, the marker 251, and/or the pair of markers 252, 253 shown in FIG. 2 can be used in the mode shown in FIG. 3 and/or the mode shown in FIG. 4. As another example, the lead section 228 shown in FIG. 3 can be used in the mode shown in FIG. 2 and/or the mode shown in FIG. 4

The present disclosure contemplates that numerals shown and/or described herein can be replaced with letters or other symbols. The present disclosure contemplates that letters shown and/or described herein can be replaced with numerals or other symbols.

The present disclosure contemplates that the modes of the display systems described and/or shown herein can be configured using button(s) of the display unit 110 and/or the software application of the computer. For example, a user can show or hide various section(s) of the display systems. As another example, a user can change the formatting of various section(s) of the display systems. For example, a format of the time value of the time section 217 can be changed between a timer mode, a stopwatch mode, or a clock mode. As another example, a format of the aim direction indicator of the aim direction section 219 can be changed between degrees or hours:minutes. As a further example, the shapes of sections (such as indicators, for example the level indicators 221, 222, 223) can be changed.

The present disclosure shows sections of the display system 200 in red. The present disclosure contemplates that other colors may be used, including but not limited to green, blue, purple, orange, and/or yellow. For example, the display system 200 modes shown in FIGS. 2-4 can be all red (as shown), all green, or can include multiple colors (such as when a full color OLED display is used).

Benefits of the present disclosure include accurate and efficient targeting of targets at various locations; accurate and efficiency display of target information to a user; fast cycling between information for different target and/or stages; and reduced or eliminated obstruction of target(s) and/or a field of view of a sight device. The present disclosure also contemplates that one or more aspects of the embodiments described herein may be substituted in for and/or combined with one or more of the other aspects described.

While the foregoing is directed to embodiments of the disclosure, other and further embodiments may be devised without departing from the basic scope thereof, and the scope thereof is determined by the claims that follow. As is apparent from the foregoing general description and the specific embodiments, while forms of the present disclosure have been illustrated and described, various modifications can be made without departing from the spirit and scope of the present disclosure.

1. A display system for sighting operations, comprising:
a sight elevation section indicating a sight elevation of a sight device;
one or more target sections corresponding respectively to one or more targets, the one or more target sections respectively comprising:
a first ballistic indicator indicating a first ballistic parameter of a respective target of the one or more targets, and
a second ballistic indicator indicating a second ballistic parameter of the respective target.

2. The display system of claim 1, wherein the first ballistic indicator is an elevation indicator, the first ballistic parameter is an elevation of a respective target, the second ballistic indicator is a windage indicator, and the second ballistic parameter is a windage of the respective target.

3. The display system of claim 2, wherein the one or more target sections respectively further comprise:
a third ballistic indicator indicating a third ballistic parameter of the respective target, wherein the third ballistic indicator is a second windage indicator, the third ballistic parameter is a second windage of the respective target, the windage corresponds to a minimum value of a windage range, and the second windage corresponds to a maximum value of the windage range.

4. The display system of claim 1, wherein the one or more target sections include a plurality of target sections corresponding respectively to a plurality of targets disposed at a plurality of distances relative to the sight device.

5. The display system of claim 1, wherein the sight elevation section, the first ballistic indicator, and the second ballistic indicator are respectively illuminated by one or more illuminators, and the display system is illuminated using a heads-up display (HUD).

6. The display system of claim 1, further comprising a time section and a battery level section, wherein:
the time section comprises a time value and a time symbol; and
the time value counts down or counts up.

7. The display system of claim 1, wherein:
the one or more target sections respectively further comprise a target indicator indicating the respective target of the one or more targets; and
the sight elevation section comprises:
a sight numeral indicating the sight elevation; and
an elevation symbol disposed adjacent to the sight numeral, wherein the elevation symbol comprises a mountain profile and an upward-pointing arrow.

8. The display system of claim 1, further comprising:
an aim direction section comprising an aim direction indicator and an aim direction symbol; and
an aim angle section comprising an aim angle indicator and an aim angle symbol.

9. The display system of claim 1, further comprising one or more shot count sections corresponding respectively to the one or more targets, wherein a number of the one or more shot count sections is equal to a number of the one or more target sections, and the one or more shot count sections respectively comprise:
one or more target indicators indicating the respective target of the one or more targets, wherein a number of the one or more target indicators is equal to a number of shots used for the respective target.

10. The display system of claim 1, wherein the display system is switchable between:
a first mode wherein the one or more target sections have a plurality of target sections; and
a second mode wherein the one or more target sections have a single target section.

11. The display system of claim 1, further comprising a marker disposed along a reticle, the marker indicating a location of a holdover calculated based on a movement speed of one or more targets.

12. The display system of claim 1, further comprising a pair of markers disposed along a reticle, the pair of markers indicating a holdover range calculated based on the second ballistic indicator and a third ballistic indicator.

13. The display system of claim 1, further comprising:
a first pan indicator oriented toward a first side of a field of view; and
a second pan indicator oriented toward a second side of the field of view.

14. A display system for sighting operations, comprising:
a level section comprising:
a first level indicator indicating that a sight device is level with respect to a gravitational direction,
a second level indicator on a first side of the first level indicator, the second level indicator indicating that the sight device is offset from the gravitational direction in a first direction, and
a third level indicator on a second side of the first level indicator, the third level indicator indicating that the sight device is offset from the gravitational direction in a second direction that is opposite of the first direction;
a time section comprising a time value; and
a controller configured to count up or count down the time value.

15. The display system of claim 14, further comprising one or more ballistic indicators.

16. The display system of claim 14, wherein the second level indicator and the third level indicator are directionally oriented toward the first level indicator.

17. The display system of claim 16, wherein the first level indicator has a solid shape, and the second level indicator and the third level indicator respectively include an apex pointed toward the first level indicator.

18. The display system of claim 14, wherein the time section further comprises a visual marker, the controller is configured to erode the visual marker, and the erosion corresponds to a time lapse of the time value.

19. A sight device comprising:
one or more objective lenses;
one or more ocular lenses;
one or more magnifying lenses between the one or more objective lenses and the one or more ocular lenses; and
a display unit operable to display one or more sections of a display system, the display unit oriented to illuminate the one or more sections onto a beam splitter between the one or more magnifying lenses and the one or more ocular lenses, the one or more sections comprising:
a level section, and
a time section.

20. The sight device of claim 19, wherein the beam splitter comprises a transparent plate oriented at an angle relative to a plane extending orthogonally relative to a longitudinal axis of the sight device, and the angle is within a range of 20 degrees to 65 degrees.
